(19) United States
(12) Patent Application Publication
(10) Pub. No.: US 2021/0299965 A1
(43) Pub. Date: Sep. 30, 2021

(54) THREE-DIMENSIONAL SHAPING APPARATUS AND THREE-DIMENSIONAL SHAPED ARTICLE PRODUCTION METHOD

(71) Applicant: SEIKO EPSON CORPORATION, Tokyo (JP)

(72) Inventor: Akihiko TSUNOYA, Okaya-shi (JP)

(21) Appl. No.: 17/211,464

(22) Filed: Mar. 24, 2021

(30) Foreign Application Priority Data
Mar. 27, 2020 (JP) 2020-057298

(51) Int. Cl. B29C 64/393; B33Y 10/00; B33Y 30/00; B33Y 40/00; B33Y 50/02; B29C 64/35; B29C 64/209

(52) U.S. Cl. CPC B29C 64/393; B33Y 10/00; B33Y 30/00; B29C 64/209; B33Y 50/02; B29C 64/35; B33Y 40/00

(57) ABSTRACT

A three-dimensional shaping apparatus includes a nozzle having a flow channel, through which a shaping material flows, and an ejection port, which communicates with the flow channel, and from which the shaping material is ejected toward a table, a position changing mechanism that changes a relative position of the nozzle to the table, a pressure measurement section that measures a pressure in a moving path of the shaping material, a cleaning mechanism that cleans the ejection port, and a control unit that controls the nozzle and the position changing mechanism and executes a shaping process for shaping a three-dimensional shaped article by stacking layers of the shaping material at the table, wherein the control unit executes a cleaning process for causing the cleaning mechanism to clean the nozzle by suspending the shaping process when the pressure measured by the pressure measurement section during execution of the shaping process is a first reference value or more.

The present application is based on, and claims priority from JP Application Serial Number 2020-057298, filed on Mar. 27, 2020, the disclosure of which is hereby incorporated by reference herein in its entirety.

### BACKGROUND

### 1. Technical Field

The present disclosure relates to a three-dimensional shaping apparatus and a three-dimensional shaped article production method.

### 2. Related Art

Heretofore, three-dimensional shaping apparatuses for shaping a three-dimensional shaped article by ejecting a shaping material from a nozzle to a table have been used. Among these, in order to suppress a decrease in shaping accuracy of a three-dimensional shaped article, there is a three-dimensional shaping apparatus capable of executing a shaping processing step for a three-dimensional shaped article after confirming whether or not a shaping material is normally ejected from a nozzle and cleaning the nozzle with a cleaning mechanism when the shaping material is not normally ejected from the nozzle. For example, JP-A-2019-77152 (Patent Document 1) discloses a three-dimensional shaping apparatus, in which ejection failure of a curing liquid from a nozzle is confirmed by moving the nozzle to a predetermined position in the middle of shaping of a three-dimensional shaped article, and cleaning of the nozzle is executed as needed.

However, in the three-dimensional shaping apparatus disclosed in Patent Document 1, ejection failure of a curing liquid from a nozzle is confirmed by moving the nozzle to a predetermined position, and therefore, it is difficult to detect ejection failure immediately after the occurrence of the ejection failure. On the other hand, when the frequency of confirmation of the presence or absence of ejection failure of the curing liquid from the nozzle is increased so as to make it possible to detect ejection failure immediately after the occurrence of the ejection failure, the shaping time for the three-dimensional shaped article becomes long, and the productivity of the three-dimensional shaped article decreases.

### SUMMARY

A three-dimensional shaping apparatus according to the present disclosure for solving the above problem includes a nozzle having a flow channel, through which a shaping material flows, and an ejection port, which communicates with the flow channel, and from which the shaping material is ejected toward a table, a position changing mechanism that changes a relative position of the nozzle to the table, a pressure measurement section that measures a pressure in a moving path of the shaping material, a cleaning mechanism that cleans the ejection port, and a control unit that controls the nozzle and the position changing mechanism and executes a shaping process for shaping a three-dimensional shaped article by stacking layers of the shaping material at the table, wherein the control unit executes a cleaning process for causing the cleaning mechanism to clean the nozzle by suspending the shaping process when the pressure measured by the pressure measurement section during execution of the shaping process is a first reference value or more.

### BRIEF DESCRIPTION OF THE DRAWINGS

FIG. 1 is a schematic cross-sectional view showing a configuration of a three-dimensional shaping apparatus of one embodiment of the present disclosure.

FIG. 2 is a schematic perspective view showing a configuration of a flat screw in a three-dimensional shaping apparatus of one embodiment of the present disclosure.

FIG. 3 is a schematic plan view showing a configuration of a barrel in a three-dimensional shaping apparatus of one embodiment of the present disclosure.

FIG. 4 is a schematic cross-sectional view showing a configuration of a peripheral portion of a nozzle in a three-dimensional shaping apparatus of one embodiment of the present disclosure.

FIG. 5 is a plan view showing an appearance structure of a first heat-resistant member.

FIG. 6 is a perspective view showing an appearance structure of a second heat-resistant member.

FIG. 7 is a flowchart showing a procedure of a three-dimensional shaped article production method performed using a three-dimensional shaping apparatus of one embodiment of the present disclosure.

### DESCRIPTION OF EXEMPLARY EMBODIMENTS

First, the present disclosure will be schematically described.

A three-dimensional shaping apparatus according to a first aspect of the present disclosure for solving the above problem includes a nozzle having a flow channel, through which a shaping material flows, and an ejection port, which communicates with the flow channel, and from which the shaping material is ejected toward a table, a position changing mechanism that changes a relative position of the nozzle to the table, a pressure measurement section that measures a pressure in a moving path of the shaping material, a cleaning mechanism that cleans the ejection port, and a control unit that controls the nozzle and the position changing mechanism and executes a shaping process for shaping a three-dimensional shaped article by stacking layers of the shaping material at the table, wherein the control unit executes a cleaning process for causing the cleaning mechanism to clean the nozzle by suspending the shaping process when the pressure measured by the pressure measurement section during execution of the shaping process is a first reference value or more.

When ejection failure occurs, the pressure in the moving path of the shaping material increases, however, according to this aspect, when the pressure measured by the pressure measurement section during execution of the shaping process is the first reference value or more, the shaping process is suspended, and the cleaning process is executed. Therefore, ejection failure can be detected during execution of the shaping process, and thus, ejection failure can be detected immediately after the occurrence of the ejection failure. Accordingly, the shaping time can be shortened while suppressing a decrease in shaping accuracy of a three-dimensional shaped article.

In a three-dimensional shaping apparatus according to a second aspect of the present disclosure, in the first aspect, a plasticizing section that forms the shaping material by plasticizing a material is included, and the pressure measurement section measures a pressure in the flow channel at a position between the plasticizing section and the ejection port or in the moving path of the shaping material in the plasticizing section.

According to this aspect, the plasticizing section is included, and therefore, the shaping material can be easily formed by plasticizing a material in the plasticizing section. Further, ejection failure can be detected based on the pressure in the flow channel of the nozzle or in the moving path of the shaping material in the plasticizing section, and therefore, ejection failure can be detected with high accuracy.

In a three-dimensional shaping apparatus according to a third aspect of the present disclosure, in the second aspect, an ejection adjustment mechanism that switches between suspension and resumption of ejection of the shaping material from the ejection port is included between the plasticizing section and the ejection port, and the pressure measurement section measures a pressure in the flow channel at a position between the plasticizing section and the ejection adjustment mechanism.

According to this aspect, the ejection adjustment mechanism that switches between suspension and resumption of ejection of the shaping material from the ejection port is included, and therefore, moving of the shaping material and stopping of the shaping material in the flow channel can be easily switched. Further, the pressure measurement section measures a pressure in the flow channel at a position between the plasticizing section and the ejection adjustment mechanism, and therefore, ejection failure can be accurately detected.

In a three-dimensional shaping apparatus according to a fourth aspect of the present disclosure, in the third aspect, the control unit does not make an execution start determination for the cleaning process when the ejection adjustment mechanism is operated.

The pressure in the flow channel sometimes becomes unstable when the ejection adjustment mechanism is operated, however, according to this aspect, an execution start determination for the cleaning process is not made when the ejection adjustment mechanism is operated. Therefore, false detection of ejection failure can be suppressed.

In a three-dimensional shaping apparatus according to a fifth aspect of the present disclosure, in any one of the second to fourth aspects, the plasticizing section includes a drive motor, a screw that is rotated by the drive motor and has a groove formed face with a spiral groove formed therein, a barrel that has an opposed face opposed to the groove formed face and is provided with a communication hole, and a heating section that heats at least one of the screw and the barrel.

According to this aspect, since the plasticizing section has such a configuration, the shaping material can be effectively plasticized.

In a three-dimensional shaping apparatus according to a sixth aspect of the present disclosure, in any one of the first to fifth aspects, the control unit makes an execution start determination for the cleaning process based on an average pressure measured by the pressure measurement section during a predetermined period of time.

According to this aspect, an execution start determination for the cleaning process is made based on the average pressure during a predetermined period of time. The pressure in the moving path of the shaping material sometimes becomes unstable immediately after the start of the shaping process or the like, however, by making an execution start determination for the cleaning process based on the average pressure during a predetermined period of time, the cleaning process can be prevented from being executed in vain due to false detection of ejection failure when ejection failure does not occur.

In a three-dimensional shaping apparatus according to a seventh aspect of the present disclosure, in any one of the first to sixth aspects, the control unit resumes the shaping process when the pressure is measured to be less than a second reference value by the pressure measurement section after executing the cleaning process.

According to this aspect, the shaping process is resumed when the pressure is measured to be less than the second reference value by the pressure measurement section after executing the cleaning process. Therefore, when the shaping process is resumed, the shaping material can be prevented from leaking out from the nozzle so that the adhesion of the shaping material to a three-dimensional shaped article can be suppressed. Accordingly, a decrease in shaping accuracy of the three-dimensional shaped article can be suppressed.

In a three-dimensional shaping apparatus according to an eighth aspect of the present disclosure, in any one of the first to seventh aspects, the cleaning process includes an ejection amount adjustment process for performing adjustment of the ejection amount of the shaping material from the nozzle using at least one of a line width of the shaping material ejected from the ejection port and the ejection amount of the shaping material ejected from the ejection port.

According to this aspect, the ejection amount adjustment process is performed using at least one of the line width of the shaping material ejected from the ejection port and the ejection amount of the shaping material ejected from the ejection port in the cleaning process. Therefore, the cleaning process is executed, and also the adjustment of the ejection amount can be performed.

In a three-dimensional shaping apparatus according to a ninth aspect of the present disclosure, in any one of the first to eighth aspects, a chamber whose internal temperature is adjustable is included, and the cleaning mechanism is provided in the chamber.

According to this aspect, a chamber whose internal temperature is adjustable is included, and the cleaning mechanism is provided in the chamber. Therefore, the cleaning performance can be improved by adjusting the temperature of the cleaning mechanism.

In a three-dimensional shaping apparatus according to a tenth aspect of the present disclosure, in the ninth aspect, the chamber has a warm air inlet inside, and the cleaning mechanism has a brush that comes in contact with the ejection port at a position where warm air is introduced from the warm air inlet.

According to this aspect, the cleaning mechanism has a brush that comes in contact with the ejection port at a position where warm air is introduced from the warm air inlet. Therefore, cleaning of the nozzle can be effectively executed using the brush while adjusting the temperature at the cleaning position.

A three-dimensional shaped article production method according to an eleventh aspect of the present disclosure is a three-dimensional shaped article production method for producing a three-dimensional shaped article by ejecting a shaping material from an ejection port of a nozzle that communicates with a flow channel, through which the shaping material flows, and includes a shaping processing step of shaping the three-dimensional shaped article by stacking layers of the shaping material at a table, a pressure measurement step of measuring a pressure in a moving path of the shaping material during execution of the shaping processing step, and a cleaning processing step of cleaning the nozzle by suspending the shaping processing step when the pressure measured in the pressure measurement step is a first reference value or more.

According to this aspect, the cleaning process is executed by suspending the shaping process when the pressure measured by the pressure measurement section during execution of the shaping process is the first reference value or more. Therefore, ejection failure can be detected during execution of the shaping process, and thus, ejection failure can be detected immediately after the occurrence of the ejection failure. Accordingly, the shaping time can be shortened while suppressing a decrease in shaping accuracy of a three-dimensional shaped article.

Hereinafter, embodiments according to the present disclosure will be described with reference to the accompanying drawings. The following drawings are all schematic views and some constituent members are omitted or simplified. Further, in the respective drawings, an X-axis direction is a horizontal direction, and a Y-axis direction is a horizontal direction and also a direction orthogonal to the X-axis direction, and a Z-axis direction is a vertical direction.

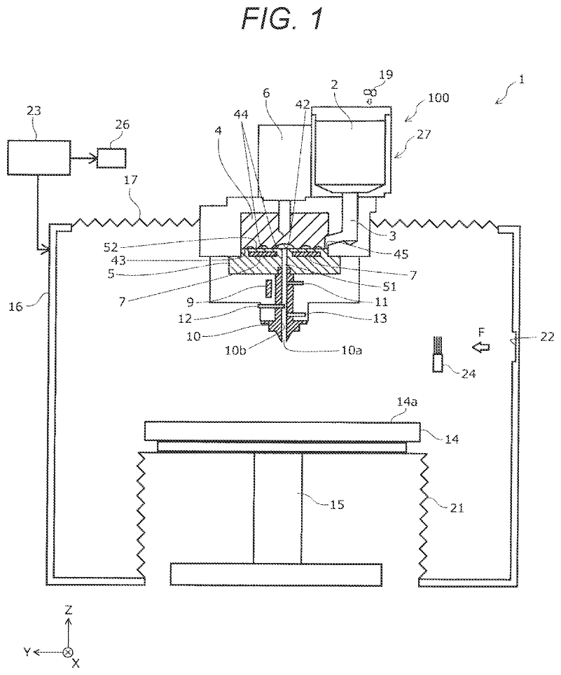

First, the entire configuration of a three-dimensional shaping apparatus 1 that is one embodiment of the present disclosure will be described with reference to FIGS. 1 to 5. The three-dimensional shaping apparatus 1 of this embodiment is a three-dimensional shaping apparatus for shaping a three-dimensional shaped article by stacking layers of a shaping material at a table 14 as a shaping stand. Note that the “three-dimensional shaping” as used herein refers to the formation of a so-called stereoscopically shaped article, and also includes, for example, the formation of a shape having a thickness even if it is in a flat plate shape or a so-called two-dimensional shape, for example, like a shape constituted by a layer corresponding to one layer. Further, the “support” is meant to include not only a case of supporting from a lower side, but also a case of supporting from a lateral side, and a case of supporting from an upper side in some cases.

As shown in FIG. 1, the three-dimensional shaping apparatus 1 of this embodiment includes a plasticizing section 27. The plasticizing section 27 includes a hopper 2 that stores a pellet 19 as a solid material constituting a three-dimensional shaped article. The pellet 19 stored in the hopper 2 is supplied, through a supply pipe 3, to a material inflow port 45 of a flat screw 4 in a substantially cylindrical shape that rotates around the Z-axis direction as a rotation axis by a driving force of a drive motor 6.

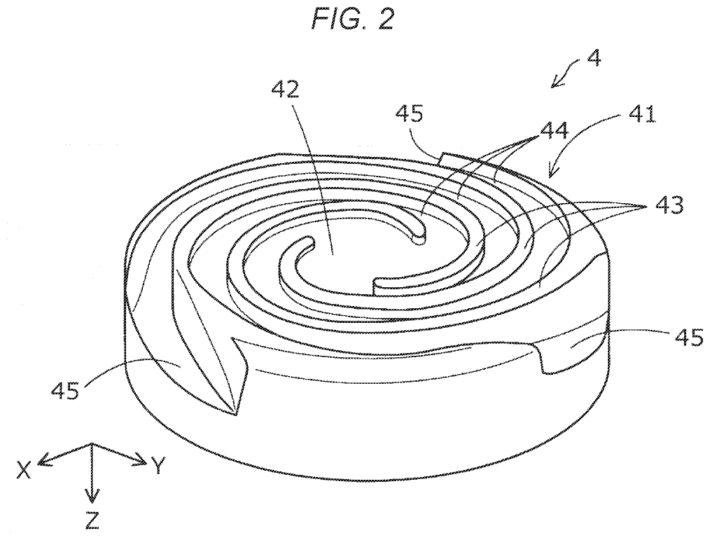

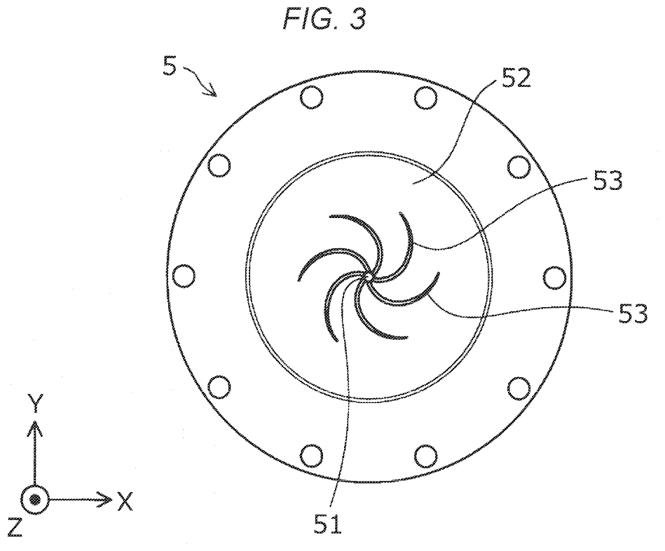

As shown in FIG. 2, a central portion 42 of a groove formed face 41 of the flat screw 4 is constituted as a recess to which one end of a groove 44 is coupled. The central portion 42 is opposed to a communication hole 51 of a barrel 5 shown in FIGS. 1 and 3. The groove 44 of the flat screw 4 is constituted by a so-called scroll groove and is formed in a spiral shape so as to draw an arc toward an outer circumferential face side of the flat screw 4 from the central portion 42. The groove 44 maybe configured in a helical shape. In the groove formed face 41, a protrusion portion 43 that constitutes a side wall portion of the groove 44 and extends along each groove 44 is provided.

In the groove formed face 41 of the flat screw 4 in this embodiment, three grooves 44 and three protrusion portions 43 are formed, however, the number thereof is not limited to three, and one or two or more arbitrary number of grooves 44 and protrusion portions 43 may be formed, respectively. Further, an arbitrary number of protrusion portions 43 may be provided according to the number of grooves 44. Further, in the outer circumferential face of the flat screw 4 in this embodiment, three material inflow ports 45 are formed so as to be arranged at equal intervals along the circumferential direction. The number of material inflow ports 45 is not limited to three, and one or two or more arbitrary number of material inflow ports 45 may be formed, and the arrangement is not limited to the arrangement at equal intervals, and the material inflow ports may be formed so as to be arranged at different intervals.

As shown in FIG. 3, the barrel 5 has a substantially disk shape as the external shape and is disposed opposite to the groove formed face 41 of the flat screw 4. In the barrel 5, a circular heater 7 that is a heating section for heating the material is embedded. In the barrel 5, the communication hole 51 is formed. The communication hole 51 functions as a flow channel that guides the shaping material to a nozzle 10. The communication hole 51 is formed at the center of an opposed face 52. In the opposed face 52, a plurality of guide grooves 53, each of which is coupled to the communication hole 51, and extends in a spiral shape toward the outer circumference from the communication hole 51, are formed. The plurality of guide grooves 53 each have a function of guiding the shaping material flowing in the central portion 42 of the flat screw 4 to the communication hole 51. Note that in order to efficiently guide the shaping material to the communication hole 51, the guide groove 53 is preferably formed in the barrel 5, but the guide groove 53 need not be formed.

Since the flat screw 4 and the barrel 5 have such a configuration, by rotating the flat screw 4, the pellet 19 is supplied to a space portion formed between the groove formed face 41 of the flat screw 4 and the opposed face 52 of the barrel 5 corresponding to the position of the groove 44, and the pellet 19 moves to the central portion 42 from the material inflow port 45. When the pellet 19 moves in the space portion made by the groove 44, the pellet 19 is melted by heat of the heater 7. Further, the pellet 19 is pressurized by a pressure accompanying the movement in the narrow space portion. In this manner, the pellet 19 is plasticized and supplied to the nozzle 10 through the communication hole 51 and injected from an ejection port 10a. In this embodiment, the heater 7 is embedded in the barrel 5, but the heater 7 may be disposed at any place as long as the pellet 19 is melted, and for example, the heater 7 may be embedded in the flat screw 4.

Further, as shown in FIG. 1, in the nozzle 10, a flow channel 10b that is coupled to the communication hole 51 and has the ejection port 10a in a tip portion is formed. That is, the communication hole 51 and the flow channel 10b constitute a moving path of the shaping material formed in the plasticizing section 27. Then, around the nozzle 10, a heater 9 that heats the shaping material flowing through the flow channel 10b, a pressure measurement section 11 that measures the internal pressure of the flow channel 10b, a flow rate adjustment mechanism 12 for the shaping material flowing through the flow channel 10b, and a suction section 13 that releases the internal pressure of the flow channel 10b are provided.

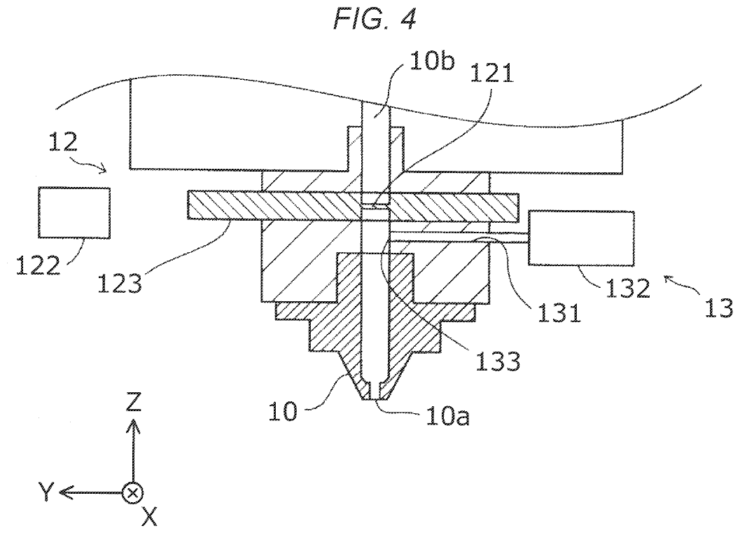

As shown in FIG. 4, the flow rate adjustment mechanism 12 includes a butterfly valve 121, a valve drive section 122, and a drive shaft 123. The flow rate adjustment mechanism 12 is provided in the flow channel 10b and controls the flow rate of the shaping material moving through the flow channel 10b. The butterfly valve 121 is a plate-shaped member obtained by processing a portion of the drive shaft 123 into a plate shape. The butterfly valve 121 is rotatably placed in the flow channel 10b. The drive shaft 123 is a shaft member provided so as to be perpendicular to the flow channel 10b and crosses the flow channel 10b at right angles. The drive shaft 123 is provided so that the position of the butterfly valve 121 becomes a position where the drive shaft 123 and the flow channel 10b cross each other.

The valve drive section 122 is a drive section having a mechanism for rotating the drive shaft 123. The butterfly valve 121 is rotated by the rotation drive force of the drive shaft 123 generated by the valve drive section 122. Specifically, the butterfly valve 121 is rotated by the rotation of the drive shaft 123 so that the position of the butterfly valve 121 is any of the following positions: a first position where the moving direction of the shaping material in the flow channel 10b (−Z direction) and the surface direction of the butterfly valve 121 become substantially perpendicular; a second position where the moving direction of the shaping material in the flow channel 10b and the surface direction of the butterfly valve 121 become substantially parallel; and a third position where the moving direction of the shaping material in the flow channel 10b and the surface direction of the butterfly valve 121 form any angle of more than 0° and less than 90°. In FIG. 4, a state where the position of the butterfly valve 121 is the first position is shown.

By rotating the butterfly valve 121, the area of the opening formed in the flow channel 10b is adjusted. By adjusting the area of the opening, the flow rate of the shaping material moving through the flow channel 10b is adjusted. Further, by bringing about a state where the area of the opening is zero (a state where the butterfly valve 121 closes the flow channel 10b) , a state where the flow rate of the shaping material moving through the flow channel 10b is zero can also be brought about. That is, the flow rate adjustment mechanism 12 can control start and stop of flowing of the shaping material moving through the flow channel 10b, and adjustment of the flow rate of the shaping material.

The suction section 13 is coupled between the butterfly valve 121 and the ejection port 10a in the flow channel 10b. The suction section 13 suppresses tailing that is a phenomenon in which the shaping material drips from the nozzle 10 and is formed into a string-like shape by temporarily sucking the shaping material in the flow channel 10b when stopping the ejection of the shaping material from the nozzle 10. In this embodiment, the suction section 13 is constituted by a plunger. The suction section 13 is driven by a suction section drive section 132 under the control of the control unit 23. The suction section drive section 132 is constituted by, for example, a stepping motor, a rack and pinion mechanism that converts the rotational force of a stepping motor into a translational motion of a plunger, or the like.

A send-out port 133 is an opening provided in the flow channel 10b. A sending channel 131 is constituted by a through-hole that linearly extends and crosses the flow channel 10b. The sending channel 131 is a flow channel for a gas coupled to the suction section drive section 132 and the send-out port 133. A gas sent out from the suction section drive section 132 passes through the sending channel 131 and is sent into the flow channel 10b from the send-out port 133. The gas supplied into the flow channel 10b pressure-feeds the shaping material remaining in the flow channel 10b to the ejection port 10a side by further continuously supplying the gas from the suction section drive section 132. The pressure-fed shaping material is ejected from the ejection port 10a.

According to such a configuration, the three-dimensional shaping apparatus 1 of this embodiment can promptly eject the shaping material in the flow channel 10b from the ejection port 10a. Further, ejection of the molten shaping material from the ejection port 10a can be promptly stopped. Note that the shape of the opening of the send-out port 133 coupled to the flow channel 10b is smaller than the shape of the cross section perpendicular to the moving direction of the shaping material in the flow channel 10b. According to this, the shaping material moving in the flow channel 10b can be prevented from flowing in from the send-out port 133 and flowing backward inside the sending channel 131.

The three-dimensional shaping apparatus 1 of this embodiment includes the plasticizing section 27, the nozzle 10, and the like as described above, and these can move along the X-axis direction and the Y-axis direction as an ejection unit 100. The ejection unit 100 moves along the X-axis direction and the Y-axis direction by controlling a position changing mechanism 26 by the control unit 23. As shown in FIG. 1, the three-dimensional shaping apparatus 1 of this embodiment includes a chamber 16 whose internal temperature is adjustable, and the ejection port 10a is disposed inside the chamber 16. Then, at the position opposed to the ejection port 10a, the table 14 for shaping a three-dimensional shaped article is provided. The table 14 can move along the Z-axis direction through a moving mechanism 15 and is also disposed so that a shaping face 14a for a three-dimensional shaped article is located inside the chamber 16. The chamber 16 of this embodiment is configured to include a warm air inlet 22 for introducing warm air into the chamber 16 in an air blowing direction F, but it is not limited to the chamber 16 having such a configuration, and for example, a configuration in which a heater is included inside the chamber 16 may be adopted.

As shown in FIG. 1, in the three-dimensional shaping apparatus 1, the ejection unit 100 in which the ejection port 10a is disposed inside the chamber 16 can move along the X-axis direction and the Y-axis direction, and also a first heat-resistant member 17 is included so that heat inside the chamber 16 does not escape to the outside of the chamber 16. Further, the table 14 with the shaping face 14a disposed inside the chamber 16 can move along the Z-axis direction, and also a second heat-resistant member 21 is included so that heat inside the chamber 16 does not escape to the outside of the chamber 16.

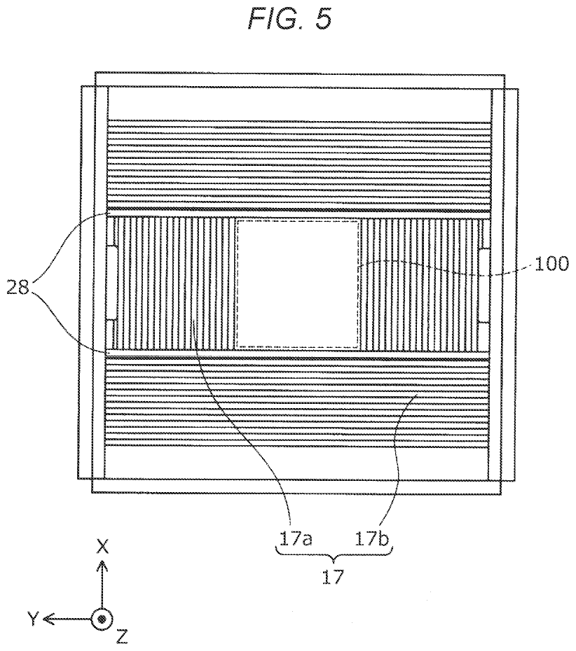

The first heat-resistant member 17 includes a structure that expands and contracts in the horizontal direction in response to the movement of the ejection unit 100 in the horizontal direction. As shown in FIG. 5, in the three-dimensional shaping apparatus 1, two rails 28 that are slidably movable along the Y-axis direction are extended along the X-axis direction, and the ejection unit 100 is attached between the two rails 28 so as to be slidably movable along the X-axis direction. The first heat-resistant member 17 is constituted by a first cover 17a that expands and contracts in the X-axis direction and a second cover 17b that expands and contracts in the Y-axis direction. In this embodiment, the first cover 17a and the second cover 17b each have heat resistance capable of withstanding the internal temperature of the chamber 16, and have a bellows-shaped expandable and contractible structure. As the first cover 17a, one set is disposed so as to sandwich the ejection unit 100 in the X-axis direction between the two rails 28. As the second cover 17b, one set is disposed so as to sandwich the ejection unit 100 in the Y-axis direction outside the two rails 28. In this embodiment, the first heat-resistant member 17 is configured by coating a glass fiber woven fabric with silicone. The configuration of the first heat-resistant member 17 is not limited thereto, and for example, it may be configured by coating a glass fiber woven fabric with a fluororesin in place of silicone.

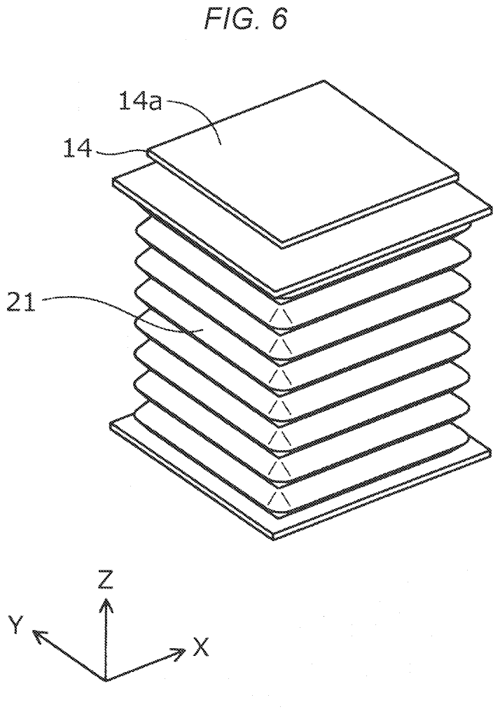

The second heat-resistant member 21 is configured in the same form by the same material as the first heat-resistant member 17 except the arrangement direction. Specifically, the second heat-resistant member 21 has heat resistance capable of withstanding the internal temperature of the chamber 16, and has a bellows-shaped expandable and contractible structure. As shown in FIG. 6, the table 14 has a rectangular shape, and the second heat-resistant member 21 is provided corresponding to each of the four sides of the table 14.

Note that the three-dimensional shaping apparatus 1 of this embodiment is configured to include one ejection unit 100 that injects the shaping material, but may be configured to include a plurality of ejection units 100 that inject the shaping material or may include the ejection unit 100 that injects a support material. Here, the support material is a material for forming a support material layer for supporting a shaping material layer.

As shown in FIG. 1, the three-dimensional shaping apparatus 1 of this embodiment includes a brush 24 as the cleaning mechanism that cleans the ejection port 10a by moving the ejection unit 100. However, there is no limitation on the configuration of the cleaning mechanism, and a cleaning mechanism having a configuration other than the brush such as a wiper blade may be included.

Further, as shown in FIG. 1, the three-dimensional shaping apparatus 1 of this embodiment includes the control unit 23, and the control unit 23 controls various drives of the three-dimensional shaping apparatus 1. The control unit 23 is electrically coupled to the ejection unit 100, the position changing mechanism 26, the moving mechanism 15, and a temperature adjustment mechanism for the chamber 16. The respective constituent members of the three-dimensional shaping apparatus 1 are driven under the control of the control unit 23, and the shaping process, the cleaning process, or the like is executed.

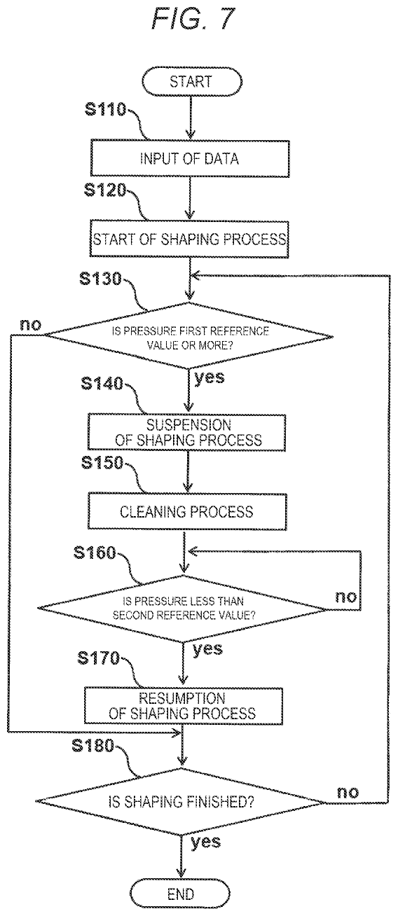

Next, a three-dimensional shaped article production method to be executed using the three-dimensional shaping apparatus 1 of this embodiment will be described with reference to FIG. 7. As described above, the three-dimensional shaping apparatus 1 of this embodiment includes the nozzle 10 having the flow channel 10b, through which the shaping material flows, and the ejection port 10a, which communicates with the flow channel 10b, and from which the shaping material is ejected to the table 14. Further, the apparatus includes the position changing mechanism 26 that changes a relative position of the nozzle 10 to the table 14, the pressure measurement section 11 that measures the pressure in the moving path of the shaping material, and the brush 24 as the cleaning mechanism that cleans the ejection port 10a. Here, the pressure measurement section 11 is constituted by a pressure sensor and is provided in the flow channel 10b. A value of the pressure measured by the pressure measurement section 11 is transmitted to the control unit 23.

When the three-dimensional shaped article production method of this Example is started, first, in Step S110, data of a three-dimensional shaped article to be shaped is input. Then, in Step S120, a shaping processing step is started. As described above, the three-dimensional shaping apparatus 1 of this embodiment includes the control unit 23, and by the control unit 23, the nozzle 10 and the position changing mechanism 26 are controlled, and the shaping processing step of shaping a three-dimensional shaped article is executed by stacking layers of the shaping material at the table 14.

Subsequently, in Step S130, the control unit 23 determines whether or not the measurement result of the pressure in the flow channel 10b by the pressure measurement section 11 is a first reference value or more. That is, it is determined whether or not the ejection port 10a is in a state of being able to appropriately eject the shaping material. This is because when the flow channel 10b in the vicinity of the ejection port 10a is clogged with the shaping material and the ejection port 10a is in a state of not being able to appropriately eject the shaping material, the pressure in the flow channel 10b increases. Then, when it is determined that the measurement result of the pressure in the flow channel 10b is the first reference value or more, the process proceeds to Step S140, and when it is determined that the measurement result of the pressure in the flow channel 10b is less than the first reference value, the process proceeds to Step S180.

In Step S140, under the control of the control unit 23, the shaping processing step is suspended. Then, the process proceeds to Step S150, and the cleaning processing step is executed. In the cleaning processing step of Step S150, the ejection unit 100 is moved to a contact position with the brush 24 that is the cleaning position, and the ejection port 10a is brushed with the brush 24. When the cleaning processing step of Step S150 is finished, the process proceeds to Step S160. The cleaning process is not particularly limited, and instead of brushing of the ejection port 10a with the brush 24, for example, the shaping material may be purged from the nozzle 10 or the like as the cleaning process.

In Step S160, the control unit 23 determines whether or not the measurement result of the pressure in the flow channel 10b by the pressure measurement section 11 is less than a second reference value. In this Example, the second reference value is set to the same pressure as the first reference value, but may be set to a different pressure from the first reference value. Then, the process waits by repeating Step S160 until it is determined that the measurement result of the pressure in the flow channel 10b is less than the second reference value, and after it is determined that the measurement result of the pressure in the flow channel 10b is less than the second reference value, the process proceeds to Step S170 and the shaping processing step is resumed. Here, when the clogging of the flow channel 10b in the vicinity of the ejection port 10a with the shaping material is eliminated, the pressure in the flow channel 10b decreases. Therefore, in Step S160, it is determined whether or not the ejection port 10a is appropriately cleaned by executing the cleaning processing step of Step S150, and when it is determined that the measurement result of the pressure in the flow channel 10b is less than the second reference value, the process proceeds to Step S170 and the shaping processing step is resumed, and when it is determined that the measurement result of the pressure in the flow channel 10b is the second reference value or more, the process returns to Step S150, and the cleaning processing step may be executed again.

Then, in Step S180, the control unit 23 determines whether or not shaping based on the data input in Step S110 is finished. When it is determined that shaping is finished by the control unit 23, the three-dimensional shaped article production method of this Example is finished. On the other hand, when it is determined that shaping is not yet finished by the control unit 23, the process returns to Step S130, and Step S130 to Step S180 are repeated until it is determined that shaping is finished in Step S180. In the three-dimensional shaped article production method of this Example, for example, the flow from Step S130 to Step S180 can be regarded as the shaping processing step for one layer.

As described above, in the three-dimensional shaped article production method of this Example, under the control of the control unit 23, the shaping processing step (Step S120 to Step S180) of shaping a three-dimensional shaped article by stacking layers of the shaping material at the table 14, and the cleaning processing step (Step S150) of causing the brush 24 as the cleaning mechanism to clean the nozzle 10 by suspending the shaping processing step when the pressure is measured to be the first reference value or more by the pressure measurement section 11 during execution of the shaping processing step are executed. In this manner, by suspending the shaping process and executing the cleaning processing step when the pressure measured by the pressure measurement section 11 during execution of the shaping process is the first reference value or more, ejection failure can be detected during execution of the shaping process, so that ejection failure can be detected immediately after the occurrence of the ejection failure. Therefore, by executing the three-dimensional shaped article production method of this Example, the shaping time can be shortened while suppressing a decrease in shaping accuracy of a three-dimensional shaped article.

As described above, the three-dimensional shaping apparatus 1 of this embodiment includes the plasticizing section 27 that forms a shaping material by plasticizing a solid material. By including the plasticizing section 27, a shaping material can be easily formed by plasticizing a solid material using the plasticizing section 27. Further, in the three-dimensional shaping apparatus 1 of this embodiment, the pressure measurement section 11 measures a pressure in the flow channel 10b at a position between the plasticizing section 27 and the ejection port 10a. However, the forming position of the pressure measurement section 11 is not particularly limited. For example, the pressure measurement section 11 may be configured to measure the pressure in the moving path of the shaping material in the plasticizing section 27 such as the communication hole 51. By detecting ejection failure based on the pressure in the flow channel 10b of the nozzle 10 or the moving path of the shaping material in the plasticizing section 27, ejection failure can be detected with high accuracy.

As described above, the three-dimensional shaping apparatus 1 of this embodiment includes the flow rate adjustment mechanism 12 and the suction section 13. The flow rate adjustment mechanism 12 and the suction section 13 are provided between the plasticizing section 27 and the ejection port 10a, and play a role as an ejection adjustment mechanism that switches between suspension and resumption of ejection of the shaping material from the ejection port 10a. Then, the pressure measurement section 11 is configured to measure the pressure in the flow channel 10b at a position between the plasticizing section 27 and the ejection adjustment mechanism. In this manner, by including the ejection adjustment mechanism that switches between suspension and resumption of ejection of the shaping material from the ejection port 10a, moving of the shaping material and stopping of the shaping material in the flow channel 10b can be easily switched. Further, by configuring the pressure measurement section 11 to measure the pressure in the flow channel 10b at a position between the plasticizing section 27 and the ejection adjustment mechanism, ejection failure can be accurately detected.

Here, the control unit 23 can cause the ejection adjustment mechanism to operate in the shaping processing step from Step S120 to Step S180, however, when the ejection adjustment mechanism is operated, the control unit 23 waits until the operation of the ejection adjustment mechanism is finished, and executes the cleaning processing step of Step S150. That is, the control unit 23 does not make an execution start determination for the cleaning processing step when the ejection adjustment mechanism is operated. The pressure in the flow channel 10b sometimes becomes unstable when the ejection adjustment mechanism is operated, however, by not making an execution start determination for the cleaning processing step when the ejection adjustment mechanism is operated, false detection of ejection failure can be suppressed.

Further, in Step S130, the control unit 23 can make an execution start determination for the cleaning processing step of Step S150 based on the average pressure measured by the pressure measurement section during a predetermined period of time. The pressure in the moving path of the shaping material sometimes becomes unstable immediately after the start of the shaping process or the like, however, by making an execution start determination for the cleaning processing step based on the average pressure during a predetermined period of time, the cleaning processing step can be prevented from being executed in vain due to false detection of ejection failure when ejection failure does not occur.

Further, as described above, the control unit 23 resumes the shaping process in Step S170 when the pressure measured by the pressure measurement section 11 in Step S160 after executing the cleaning processing step in Step S150 is measured to be less than the second reference value. Therefore, when the shaping process is resumed, the shaping material can be prevented from leaking out from the nozzle 10 so that the adhesion of the shaping material to a three-dimensional shaped article can be suppressed. Accordingly, a decrease in shaping accuracy of the three-dimensional shaped article can be suppressed.

Further, the cleaning processing step of Step S150 may include an ejection amount adjustment process for performing adjustment of the ejection amount of the shaping material from the nozzle 10 using at least one of the line width of the shaping material ejected from the ejection port 10a and the ejection amount of the shaping material ejected from the ejection port 10a. By performing the ejection amount adjustment process using at least one of the line width of the shaping material ejected from the ejection port 10a and the ejection amount of the shaping material ejected from the ejection port 10a in the cleaning processing step, the cleaning processing step is executed, and also the adjustment of the ejection amount can be performed. Here, the “line width” means an ejection width of the shaping material when the shaping material is continuously ejected from the nozzle 10.

Further, as described above, in the three-dimensional shaping apparatus 1 of this embodiment, the plasticizing section 27 includes the drive motor 6, the flat screw 4 that is rotated by the drive motor 6 and has the groove formed face 41 with the spiral groove 44 formed therein, the barrel 5 that has the opposed face 52 opposed to the groove formed face 41 and is provided with the communication hole 51, and the heater 7 that heats the barrel 5. By using a plasticizing section having such a configuration as the plasticizing section 27, the shaping material can be effectively plasticized. In the three-dimensional shaping apparatus 1 of this embodiment, the heater 7 that heats the barrel 5 is included as the heating section, but a heating section that heats the flat screw 4 may be included.

Further, as described above, in the three-dimensional shaping apparatus 1 of this embodiment, the chamber 16 whose internal temperature is adjustable is included, and the brush 24 as the cleaning mechanism is provided in the chamber 16. Therefore, the brush 24 can be heated. That is, the cleaning performance can be improved by adjusting the temperature of the cleaning mechanism.

Further, as shown in FIG. 1, in the three-dimensional shaping apparatus 1 of this embodiment, the chamber 16 has the warm air inlet 22 inside, and the brush 24 is provided on an extension line in the air blowing direction F of the warm air inlet 22. That is, the brush that comes in contact with the ejection port 10a is provided at a position where warm air is introduced from the warm air inlet 22. Therefore, in the three-dimensional shaping apparatus 1 of this embodiment, cleaning of the nozzle 10 can be effectively executed using the brush 24 while adjusting the temperature at the cleaning position.

The present disclosure is not limited to the above-mentioned Examples, but can be realized in various configurations without departing from the gist of the present disclosure. The technical features in the Examples corresponding to the technical features in the respective aspects described in “SUMMARY” of the present disclosure may be appropriately replaced or combined in order to solve part or all of the problems described above or achieve part or all of the advantageous effects described above. Further, the technical features may be appropriately deleted unless they are described as essential features in the specification.

What is claimed is:

1. A three-dimensional shaping apparatus, comprising:
a nozzle having a flow channel, through which a shaping material flows, and an ejection port, which communicates with the flow channel, and from which the shaping material is ejected toward a table;
a position changing mechanism that changes a relative position of the nozzle to the table;
a pressure measurement section that measures a pressure in a moving path of the shaping material;
a cleaning mechanism that cleans the ejection port; and
a control unit that controls the nozzle and the position changing mechanism and executes a shaping process for shaping a three-dimensional shaped article by stacking layers of the shaping material at the table, wherein
the control unit executes a cleaning process for causing the cleaning mechanism to clean the nozzle by suspending the shaping process when the pressure measured by the pressure measurement section during execution of the shaping process is a first reference value or more.

2. The three-dimensional shaping apparatus according to claim 1, wherein
a plasticizing section that forms the shaping material by plasticizing a material is included, and
the pressure measurement section measures a pressure in the flow channel at a position between the plasticizing section and the ejection port or in the moving path of the shaping material in the plasticizing section.

3. The three-dimensional shaping apparatus according to claim 2, wherein
an ejection adjustment mechanism that switches between suspension and resumption of ejection of the shaping material from the ejection port is included between the plasticizing section and the ejection port, and
the pressure measurement section measures a pressure in the flow channel at a position between the plasticizing section and the ejection adjustment mechanism.

4. The three-dimensional shaping apparatus according to claim 3, wherein
the control unit does not make an execution start determination for the cleaning process when the ejection adjustment mechanism is operated.

5. The three-dimensional shaping apparatus according to claim 2, wherein
the plasticizing section includes
a drive motor,
a screw that is rotated by the drive motor and has a groove formed face with a spiral groove formed therein,
a barrel that has an opposed face opposed to the groove formed face and is provided with a communication hole, and
a heating section that heats at least one of the screw and the barrel.

6. The three-dimensional shaping apparatus according to claim 1, wherein
the control unit makes an execution start determination for the cleaning process based on an average pressure measured by the pressure measurement section during a predetermined period of time.

7. The three-dimensional shaping apparatus according to claim 1, wherein
the control unit resumes the shaping process when the pressure is measured to be less than a second reference value by the pressure measurement section after executing the cleaning process.

8. The three-dimensional shaping apparatus according to claim 1, wherein
the cleaning process includes an ejection amount adjustment process for performing adjustment of the ejection amount of the shaping material from the nozzle using at least one of a line width of the shaping material ejected from the ejection port and the ejection amount of the shaping material ejected from the ejection port.

9. The three-dimensional shaping apparatus according to claim 1, wherein
a chamber whose internal temperature is adjustable is included, and
the cleaning mechanism is provided in the chamber.

10. The three-dimensional shaping apparatus according to claim 9, wherein
the chamber has a warm air inlet inside, and
the cleaning mechanism has a brush that comes in contact with the ejection port at a position where warm air is introduced from the warm air inlet.

11. A three-dimensional shaped article production method for producing a three-dimensional shaped article by ejecting a shaping material from an ejection port of a nozzle that communicates with a flow channel, through which the shaping material flows, comprising:
a shaping processing step of shaping the three-dimensional shaped article by stacking layers of the shaping material at a table;
a pressure measurement step of measuring a pressure in a moving path of the shaping material during execution of the shaping processing step; and
a cleaning processing step of cleaning the nozzle by suspending the shaping processing step when the pressure measured in the pressure measurement step is a first reference value or more.
